(19) United States
(12) Patent Application Publication
(10) Pub. No.: US 2013/0290226 A1
(43) Pub. Date: Oct. 31, 2013

(54) SYSTEM AND METHOD FOR SOCIAL GRAPH AND GRAPH ASSETS VALUATION AND MONETIZATION

(71) Applicant: MAYNARD DOKKEN, Toronto (CA)

(72) Inventor: MAYNARD DOKKEN, Toronto (CA)

(21) Appl. No.: 13/857,485

(22) Filed: Apr. 5, 2013

Related U.S. Application Data
(60) Provisional application No. 61/620,615, filed on Apr. 5, 2012.

(51) Int. Cl. G06N 5/02

(52) U.S. Cl. CPC G06N 5/02
USPC 706/12

(57) ABSTRACT

A system and method to provide social and graph credit scoring, valuation and monetization. The valuation and monetization system provides users, service providers and other agents with a credit scoring and rating system. An application programming interface provides a platform for integration of all types of financial, business and personal services into the logic and classification infrastructure. A graph assets and collateralization clearinghouse creates a secure platform for collateralization. The graph assets information database provides core classification services for ranking, indexing, and content analysis. In a specific embodiment a financial services provider utilizes the social credit scoring, valuation and monetization platform to process and approve qualified credit line applicants. Approval is primarily based on graph and valuation metrics provided by the system and includes an e-commerce and social metrics real time analysis for knowledge of an applicant's future and present risk profile, including credit and graph properties risks.

### FIELD OF THE INVENTION

The present invention relates to infrastructure for online platforms related to graph and graph assets valuation and monetization, and in particular core knowledge and intelligent information extraction, retrieval and presentation systems.

### BACKGROUND

Historically, customers would approach banks and capitalist to get funding for their projects, daily affairs, housing and business. When they were able to secure funding the costs associated were often based on covering risks of other customers.

Banks lend money based on credit scores. Capitalists invest money based on the ideas and whether they could produce economic gains, but this credit and monetization game is changing.

Entrepreneurs used to need several million dollars in order to get a company off the ground and test their business model. Crowd collaboration now enables ideas to disseminate, and creations to be distributed. A product or service that delivers productivity and creates value is quickly verified by crowd reactions and consumption. That consumption record represents social currency.

This digitally enabled world has similarities to the old credit score model world. Financial variables used to determine your credit score is akin to social variables that can determine a social credit score. We individually and collectively leverage and create social currency. The content and commerce we consume and share represents social currency. Social credit score is based on value; recognition, and consumption.

The current system enables classification based on credit score, and it provides valuation based on assets. However, the world is going a different direction. Classification of your social graph and graph assets provides an organized repository needed to enable social credit scoring.

Social credit scoring also has another challenge of staying up-to-date with the ever changing social world. The classification system need a real time intelligent system to evolve as the social world evolves, and this includes social credit scoring.

The many shortcomings of social graph and graph asset is starting to become apparent. The old model is no longer going to survive in the modern era. The world is looking for a solution to break away from hard wired systems without flexibility, where the user has to pay for the risk of the organization, and where the single variables that financial institutions and marketing organizations currently use to evaluate risks are actually creating more risks for the consumer.

Social capital is currently producing little benefit to the consumer. Social activities, trending, and consumption provide an enormous asset for the future, and these elements contribute to a social credit score. |Access to information and knowledge that can be used to create more social currency and assets can be ours with focus on the owners rather than holders.|[S1]

### SUMMARY OF INVENTION

The present invention generally relates to valuation and monetization of graph and graph assets. The system utilizes knowledge and information extraction and retrieval based systems with a core logic engine to manage and optimize graph and graph assets classification systems. More particularly the invention is a system and method for social graph owners and holders to receive a social credit scoring, and access to monetization services through service providers and vendors.

Merely by way of example, the invention has been applied to a computer networking environment utilizing a layer and API environment. A platform using the Layer and API infrastructure can deliver a plurality of services with a much broader range of applications. However, it should be recognized that the invention has a much broader range of applicability for social infrastructure that does not require the Layer and API infrastructure.

For example, the invention can be applied to service providers including, but not limited to: graph knowledgebase providers; financial services companies; buy-sell exchanges; ratings agencies; risk managers; social credit rating services; graph search indexing systems; trending analysis for advertising; valuation service providers; online and social site security systems; fraud detection services; and any combination of these.

The core logic engine utilizes logic theory that can manage the graph assets classification system and programmable algorithms. The system populates, through a plurality of business and database logic and stored functions, the scheduling and functions of the information extraction and retrieval engine. The use of polymorphic database modeling provides a schema for auto evolution of the core of the invention. This combined with mean average precision models (MAP) tracking provides real time measurement to deliver optimization of operations and results.

The social and e-commerce revenue index is populated using e-commerce and traditional marketing metrics extracted and retrieved from an information system. This classification is indexed to graph assets properties classification for opportunities and trending analysis and valuation through the core logic engine. The core logic engine and database manager monitors and adjusts database schema, processes, logic, routing, stored procedures, formulas and algorithms. The sub-properties ontological system provides social information in the classification database for analysis of social activity, trends, logic probabilities and statistics.

The graph logic search engine graph Uniform Resource Identifier (URI) registration database and domain server provides a network based model for search and viewing of graph, graph assets and properties. This provides a graph based domain and search system including registration, and a graph based visualization and presentation system.

The combined processes and classifications provided in the invention enable the real time valuation and monetization of graph and graph assets, the monetization and collateralization transaction gateway provides a platform for financial service companies. The many applications of this technology will be obvious to a person skilled in the art.

Still further, the present invention provides a platform that could be licensed. The licensed model and systems could be co-located or hosted at service provider locations.

Various additional features, advantages, services, providers, industries and other factors of the present invention can be more fully appreciated with reference to the detailed description and accompanying drawings.

### BRIEF DESCRIPTION OF THE DRAWINGS

FIG. 1 is a generalized diagram view of the components of the invention in accordance with various embodiments described herein.

FIG. 2 is a generalized diagram view of the classification databases and clearinghouse of the invention in accordance with various embodiments described herein.

FIG. 3 is a generalized diagram view of the graph crawler, spidering, parsing, web-bot and index system of the invention in accordance with various embodiments described herein.

FIG. 4 is a generalized diagram view of the core logic engine and knowledgebase platform, valuation, and social scoring system of the invention in accordance with various embodiments described herein.

FIG. 5 is a generalized diagram view of the monetization and secure transactional gateway of the invention in accordance with various embodiments described herein.

FIG. 6 is a generalized diagram of the Layers API server, layer and service definitions and servers, provisioning, and the access and control policy of the invention in accordance with various embodiments described herein.

FIG. 7 is a generalized diagram view of the login, authentication, authorization and services access control of the invention in accordance with various embodiments described herein.

FIG. 8 is a simplified diagram of the layer client utilizing the service provider layer and client API's for user accounts or customers, with single sign-on or delegated authentication, and authorization control of the invention in accordance with various embodiments described herein.

FIG. 9 is a simplified diagram of the graph logic search engine of the invention in accordance with various embodiments described herein.

FIG. 10 is a simplified view of the home page of the invention in accordance with various embodiments described herein.

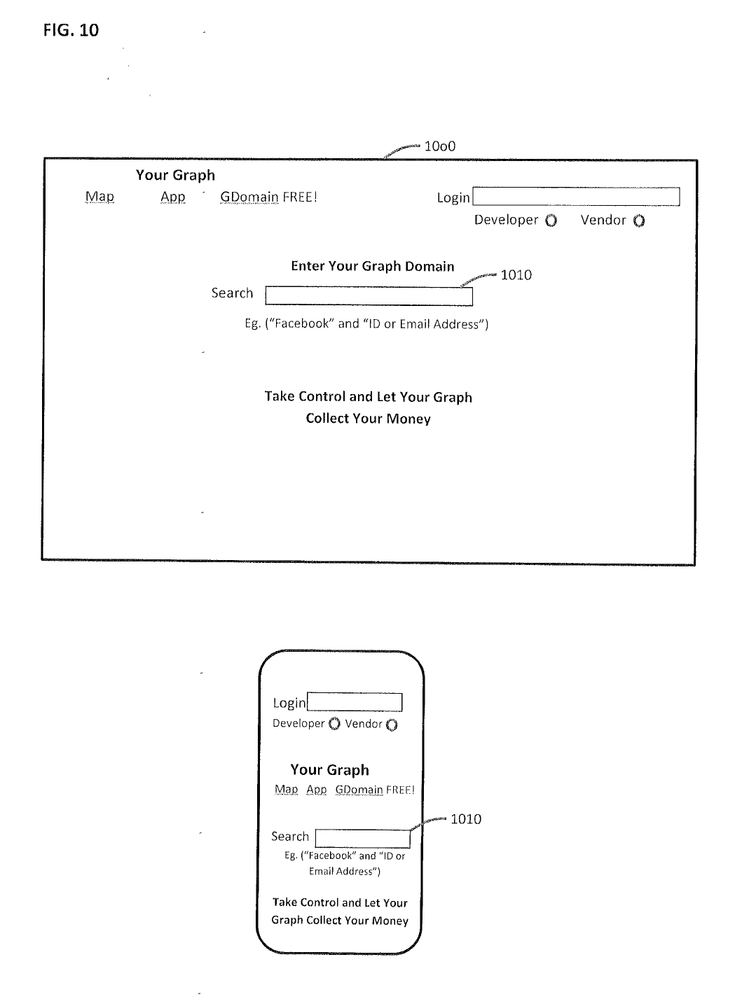

FIG. 11 is a simplified view of a result link of the invention in accordance with various embodiments described herein.

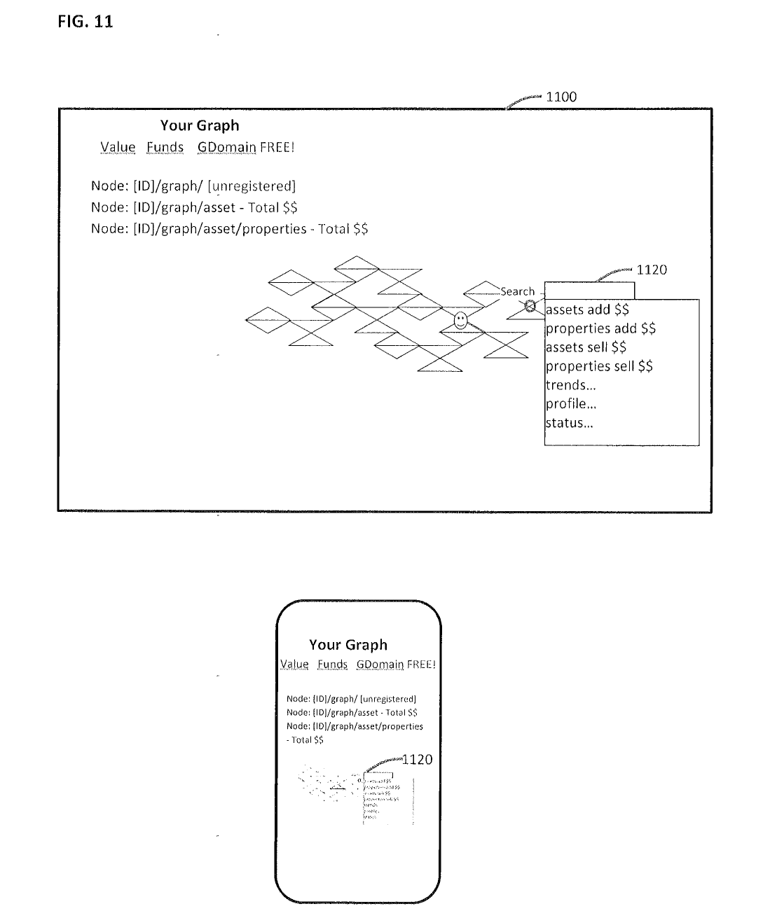

FIG. 12 is a simplified view of the Layer and API Developer Site Platform of the invention in accordance with various embodiments described herein.

### DETAILED DESCRIPTION OF THE INVENTION

The present invention generally relates to social and related graphs and graph assets, and the systems and methods to establish and enable the value and monetization process. More particularly the invention provides an infrastructure for social credit rating and graph assets properties analysis using a core logic engine.

The platform using the infrastructure can deliver a plurality of services and has a much broader range of applicability as an application programming interface development platform.

The core logic engine can use any logic theory that can use the graph assets classification system and programmable algorithm system. By populating, through a plurality of business and database logic and stored functions, the scheduling and functions of the information extraction and retrieval engine, it becomes an intelligent logic engine for graph and graph assets.

The social and e-commerce revenue index is populated using e-commerce and traditional marketing metrics. It is then indexed to the graph assets properties classification system for opportunities and trending analysis for the valuation system.

The graph logic search engine provides the graph URI registration database and domain server. This provides a graph based domain and search system, including a graph based visualization and presentation system.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

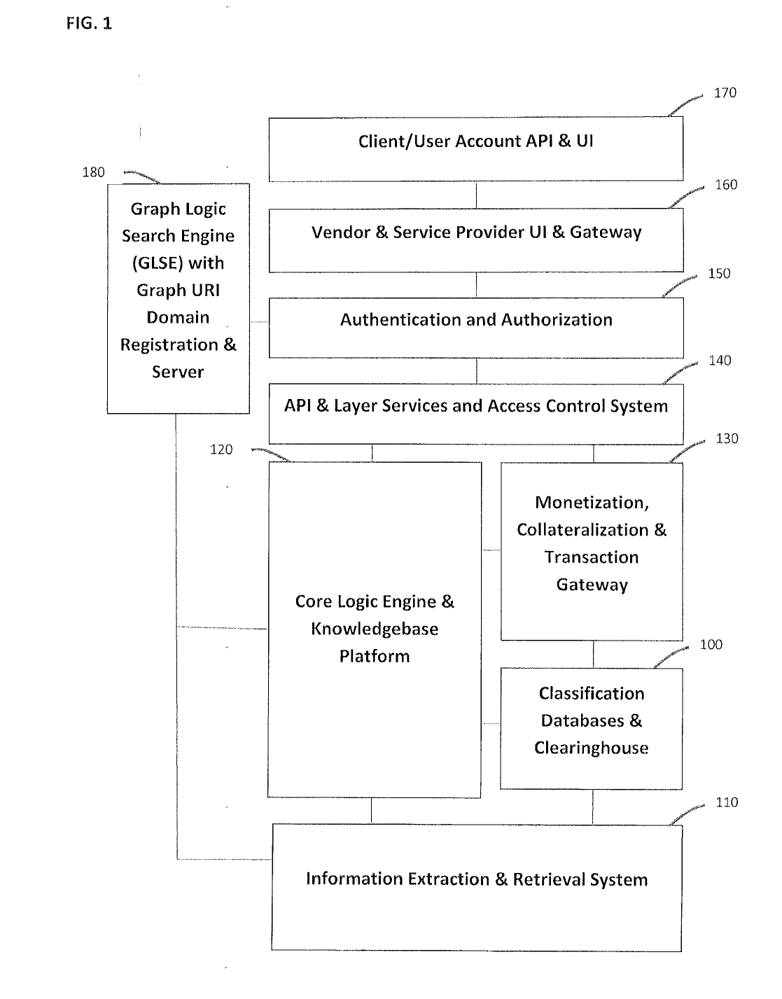

Referring to FIG. 1, the principle components of this embodiment as follows: a Classification Databases and Clearinghouse 100; an Information Extraction and Retrieval System 110; a Core Logic Engine Platform and Knowledgebase Platform with Integrated Valuation and Scoring Systems 120; a Monetization, Collateralization, & Transaction Gateway 130; an API & Layer Services and Access Control System 140; Authentication and Authorization System 150; a Vendor and Service Provider User Interface and Gateway 160; a Client/User API and User Interface 170; and a Graph Logic Search Engine with Graph URI Domain Registration & Server 180.

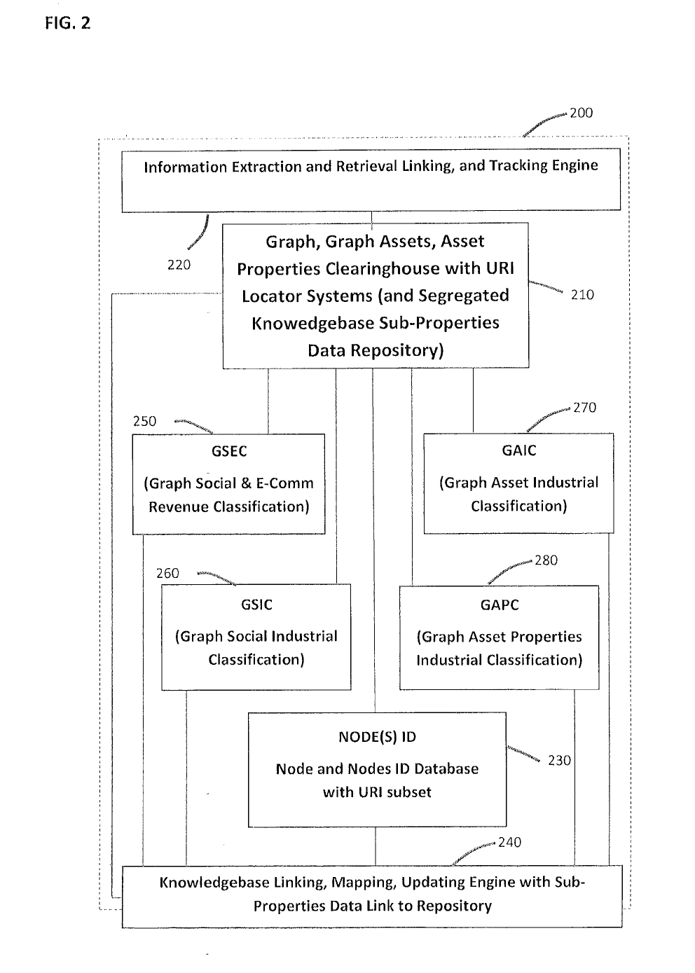

Referring to FIG. 2, the clearinghouse and classification system is at the foundation of identifying and storing graph assets. It is a fundamental building block of the knowledgebase, core logic engine database management system, and it provides the context for searching new assets and asset properties.

The system is built on a dynamic system using the knowledgebase and intelligent information extraction and retrieval systems. The social world changes fast and the classification system of this invention can change in real time. The classification system takes into consideration not only semantic but also schematic requirements. The combination of semantic and with real time classification provides one solution, the URI system with sub-properties ontology the second.

The ability to understand and deliver solutions based on this classification system is a traditional approach to a complex condition, real world structure with new world properties. Classification can include any form of property, including ontology associated with a graph asset property. It is a simple structure but provides unlimited definitions. A combination of graph logic resource description framework (RDF) Schema with URI graph naming provides existing Internet systems and search system with new technology options.

The combination of existing semantic and RDF Schema with a new world Classification and Graph URI system provides the social world options and flexibility of a structured yet customizable platform to build tomorrows solutions.

In FIG. 2, the clearinghouse components 200 represent the individual recording and lookup databases for classification and management of graphs, graph assets, graph assets properties, and graph social e-commerce & revenue classifications. The clearinghouse 210 provides the information extraction and retrieval system with the definitions for indexing information and mapping results.

The Node and Nodes Identification (ID) database uses URI locator processes to index extracted and retrieval information. There are two forms of graph holders in this index: Node, which is a single graph holder; and Nodes, which is a graph holder with multiple graphs. Either can be recorded in both formats with the same Node/Nodes ID. The URI form is as follows:

Node: or Nodes: request is a request for translation into a URL

Node Graph ID System: Node: [ID]/graph/; Node:

[ID]/graph/asset/; Node: [ID]/graph/asset/properties/(Super or Multiple Nodes from one source or holder) Nodes Graph ID System: Nodes: [ID]/graphs/; Nodes: [ID]/graphs/assets/; Nodes: [ID]/graphs/assets/properties/; Nodes: [ID]/[GSIC(s)]/[GAIC(s)]/[GPAC(s)]/

GSEC Node Graph ID System: Node(s): [ID]/graph(s)/gsec(s)/; Node(s): [ID]/graph(s)/gsec/models/; Node(s): [ID]/graph(s)/asset(s)/gsec(s)/; Node(s): [ID]/graph(s)/asset(s)/gsec/models/; Node(s): [ID]/graph(s)/asset(s)/propertie(s)/gsec(s)/; Node(s): [ID]/graph(s)/asset(s)/propertie(s)/gsec/models/

The Information Extraction and Retrieval Linking and Tracking Engine 220 is synced to the Clearinghouse index according to the most recent and valid format set by the Logic Engine. The Node/Nodes ID Database with URL Locator Subset 230 is mapped to the Core Logic Engine and Knowledgebase which maps to the Clearinghouse Sub-Properties Data 240; the central Clearinghouse Server Maps into the: the Graph Social and E-Comm Revenue Classification (GSEC) database 250; Assets Industrial Classification (GSIC) database 260; the Graph Assets Industrial Classification (GAIC) database 270; and the Graph Asset Properties Classification (GAPC) database 280

The system can use a plurality of database configurations including mapping system for information extraction and retrieval system MapReduce Framework and Core Logic Engine services.

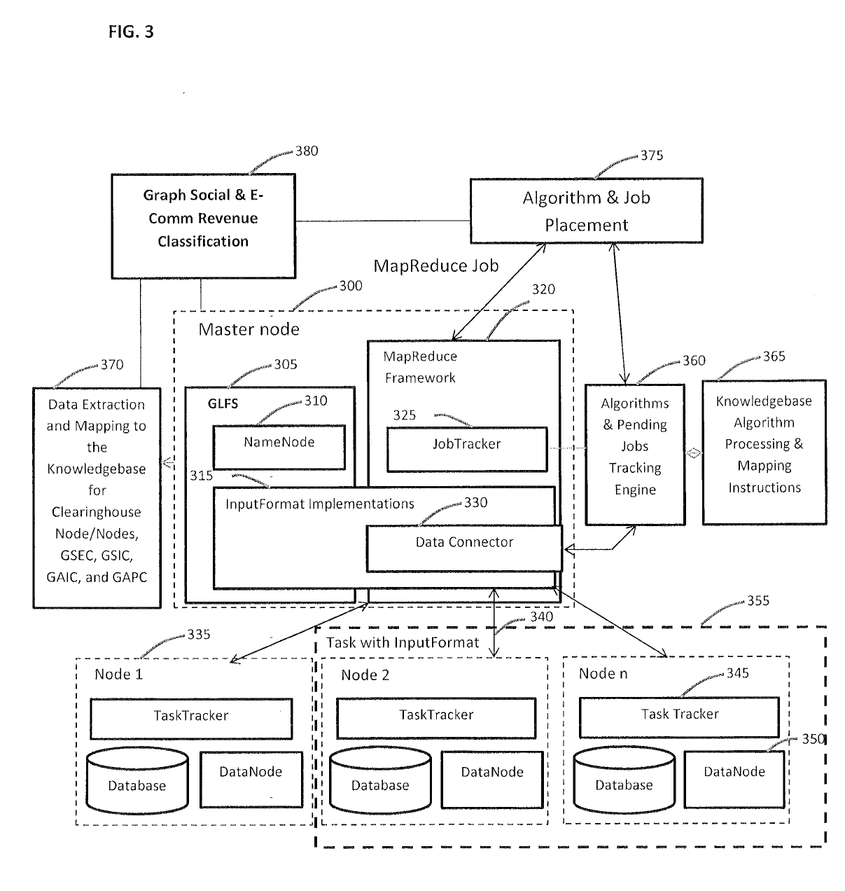

Referring to FIG. 3, a generalized diagram view of the graph crawler, spidering, parsing, web-bot and information extraction and retrieval system of the invention in accordance with various embodiments is shown. This system is designed to maximize the quality of information delivered to the knowledgebase and core logic engine through intelligent algorithm evolution and automated schema evolution system using polymorphism.

The solution is flexible and dynamic with real time impact on all aspects of this invention. It is required for the new social world. The algorithms are core to the effectiveness of the system to track non-malicious as well as malicious activities. The data cleaning and mapping component provides extraction to the knowledgebase and clearinghouse indexed as requested. The data structure is formatted based on the knowledgebase core logic engine parameters and performance polymorphism for operating efficiencies.

A preferred embodiment uses a Hadoop MapReduce structure. The framework supports data-intensive distributed applications that enable applications to work with thousands of computational independent computers and petabytes of data. Hadoop was derived from Google's MapReduce and Google File System (GFS).

The Master Node or Hadoop Distributed File System (HDFS) 300 provides a data replicating system to assure integrity in the event of a fault in any components. The system envisioned utilizes multiple Master Nodes 300 across with multiple worker Nodes 335. A slave or Worker Node 335 acts as both a DataNode 350 and TaskTracker 345, though it is possible to have Data-only Worker Nodes, and Compute-only Worker Nodes for retrieval only tasks. The HDFS 300 is managed through a dedicated NameNode 310 server to host the filesystem index, and a secondary NameNode that can generate snapshots of the namenode's memory structures, thus preventing filesystem corruption and reducing loss of data. The standalone JobTracker server 325 can manage job scheduling.

HDFS 300 is a distributed, scalable, and portable filesystem written in Java for the Hadoop framework. Each node in a Hadoop instance typically has a single Datanode 335; a cluster of Datanodes 355 form the HDFS cluster.

Each Datanode 335 serves up blocks of data over the network using a block protocol specific to HDFS. The filesystem uses the Transmission Control Protocol/Internet Protocol (TCP/IP) layer for communication; clients use remote procedure calls (RPC) to communicate between each other. Data nodes can talk to each other to rebalance data, to move copies around, and to keep the replication of data high.

The Secondary Namenode regularly connects with the Primary Namenode and builds snapshots of the Primary Namenode's directory information, which is then saved to local/remote directories. These checkpointed images can be used to restart a failed Primary Namenode without having to replay the entire journal of filesystem actions, and then edit the log to create an up-to-date directory structure.

The Jobtracker 325 schedules map/reduce jobs to Tasktrackers 345 with an awareness of the data location.

File access can be achieved through the native Java API, the Thrift API to generate a client in the language of the users' choosing (C++, Java, Python, PHP, Ruby, Erlang, Perl, Haskell, C#, Cocoa, Smalltalk, and OCaml), the command-line interface, or browsed through the HDFS-UI webapp over HTTP. The system integrates an Algorithm Scheduler 355 with the JobTracker 325 and TaskTracker 345 and sync with the Core Logic Engine to adjust the Mapping 365 based on the protocol defined. Data Extraction and Mapping 370 to the Core Logic Engine and Clearinghouse is also defined by the results of the Algorithm including analysis of Pending Jobs Database 360 as defined by the Core Logic Engine.

The Information Extraction and Retrieval System provides crawling-spidering, scraping-parsing, web-bots, streaming, multi-media and all forms of information extraction and retrieval including extraction and retrieval of news feed based information determined by the requirements of the instructions from the Core Logic Engine including synced external market databases for the Graph Social & E-Comm Revenue Classification system 380.

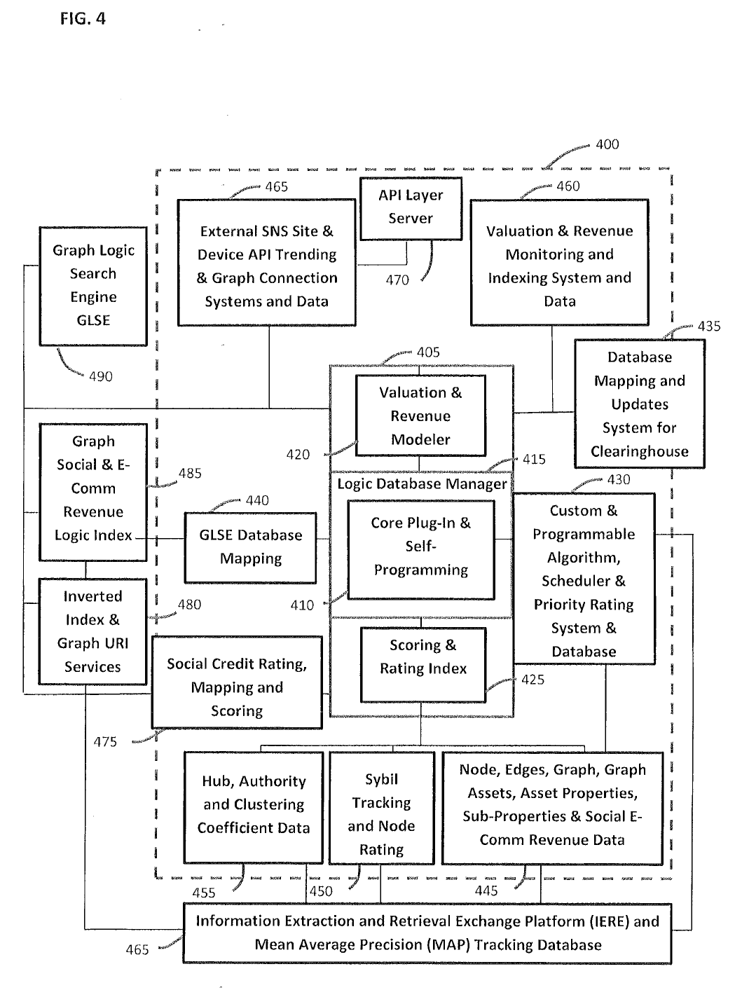

Referring to FIG. 4, a diagram of the knowledgebase, valuation and social scoring system is illustrated. This system analyzes and scores all processes and intelligently analyzes new information with a Radial Basis Function (RBF) engine. Rule extraction is generated from and using programmable algorithms based on a simplified RBF neural network analysis to find universal approximation from the information extraction and retrieval and system data.

The universal approximator model is based on a multilayer feed-forward network and neural network strategy designed to optimize the efficiencies of interconnecting systems and operators with a parallel function universe similar to the social graphs but with a structural basis for analysis. An opportunity to deliver core decision making processes that look for opportunities to optimize systems and results. An example is below.

The core logic engine database control schema utilizes a subtype polymorphism or inclusion polymorphism wherein the table or record name may denote instances of many different classes as long as they are related by some common super class and thus can be handled via a common interface. This enables an efficient model to populate and evolve the graph and graph sub-properties databases.

The decision boundary of rules extracted and mapped to the URI and Classification system during the operation of the RBF engine are the basis for the graph logic engine. This overlaps analysis of the same graph and can expose a number of hidden graph assets and properties while maintaining classification accuracy. This can be derived from a graph holder registering many graphs which inter-relate and have similar asset properties. Both semantic and ontological issues can be addressed by learning systems looking at the graph logic search activities and similarities of graph asset properties and populating the sub-properties database. This sub-properties database is used by the knowledgebase to identify trends, to learn more about graph asset properties, this combination of semantics and ontology on the sub properties level further defines needs and desires of nodes or graph holders. It also provides the fourth level of analysis which defines the best model for e-commerce opportunities as well as social differences between nodes.

It is understood that the behavior in a social network and graph is intrinsically non-deterministic, sporadic and not intermittent. The behavior of most nodes or graph holders is not necessarily deterministic, in that the subsequent state is determined both by the processes predictable actions and by a random element. For an example process such as looking at a car promotion may involve many aspects of decision making. If we take this example and apply to the RBF engine and assume most graph holders or nodes wish for normality in their activity we then apply this activity to a stochastic view. We look at the data flow from this node or graph holder activity using a stochastic kernel (mapping) analyzer and determine statistically, stochastically, through a kernel estimate the conditional or estimated kernel density or options for this decision. So instead of dealing with only one possible way the process might develop over time (as in the case, for example, of solutions of an ordinary differential equation for the same situation), in a stochastic or random process there is some indeterminacy described by probability distributions (describes the probability of a random variable taking certain courses). These probability distributions then become part of the graph asset properties sub properties component used by the core logic engine to determine the probable node or graph holder actions with scoring. These probabilities are defined and placed into the classification system to determine and compare the possible conduct of others within the node or graph holder graph. These processes provide learning processes that drive the knowledgebase to the level of an intelligent learning system.

Many of these sub-property factors provide weights of the graph assets and properties and are used to calculate and produce more accurate and concise scores, rules, definitions, data schema and algorithms based on the totality of this information which is requested from the graph holder and derived from their social and revenue inquiry activities. This system provides for the ontological and semantic population of sub-properties classification models associated with graph assets properties. This system can provide both learning processes as well structured social knowledge profiles.

To this end the core logic engine database schema enables the real time evolution of the classification and URI contexts. These principles can be combined with many different factors and to provide core learning system for the information extraction and retrieval system (shown in FIG. 2).

The system optimizes algorithms to maximize the quality and level of each search and query process, and maximize the search engine results. The learning system is based on a continued flow of new information and evolving database schemas through real time analysis. Using classifications, external information sources, and comparables in social and e-commerce revenue 485 activities the social & e-commerce revenue database provides a real world basis for valuation systems.

Valuation is variable in the core logic system and for the classification processes. The combined social and e-commerce revenue statistics with the known and accepted valuation principles for customer assets means the users and holders of these graphs can now determine realistically what the value is if they want to maximize the potential. The core logic engine uses a version of customer equity and customer lifetime value graph assets oriented to social graphs. Using known and accepted evaluation processes combined with customer retention probability analysis provides a greater degree of assessment and certainty by combining social credit scoring with available real time monitoring.

The system and database schema is always evolving and the database formulas and stored procedures evolve based on results and based on real world information. The number of relationships, the number of graph assets of types of opportunities, the number and type of properties that are connected to the graph assets sub properties are adjusted based on real time social and e-commerce revenue models and graph holder assets. Further the system with automated probabilistic methods to determine retention rates and adjustments based on real world real time changes the monitoring of any valuation makes this process unique.

Social credit mapping and scoring has become a challenge facing consumers and business alike. Its use has become an opportunity and challenge with reputation or more important credit and employment decisions based at times on the continue high rating of this condition.

Most individuals have no idea how to interact or adjust their social credit mapping and rating activities necessary to maximize these parameters. With credit rating agencies, it is a simple matter of paying your bills, but these new factors can actually turn good credit into no credit. Most of these systems are utilizing single source models that are incomplete and therefore deliver inaccurate and sometimes troubling conclusions. The social credit and employment scoring envisioned would change this and deliver to individuals, businesses, and financial institutions a rating based on a complete set of graph and graph asset statistics in real time. It will provide a method for these entities and institutions to assure themselves of the integrity of customers including utilizing Sybil crawlers to protect against malicious user accounts within social graphs. The platform will provide a rating that takes into account all the variables, all the social graph conditions, with an evolving schema utilizing sub-properties knowledge and ratings, and in real time.

The knowledgebase 400 core logic engine platform 405 is comprised of a core plug-in & self-programming logic engine 410, logic database manager 415, valuation and revenue modeler 420, and scoring and ratings index 425. These core systems along with the custom & programmable algorithm database and scheduler combined with the database and mapping for the clearinghouse and graph logic search engine (GLSE) manage and develop the intelligent processes that operate the knowledgebase.

For the above example the core logic or the radial basis function engine resides in the core plug-in & self-programming logic engine 410 with data processes managed by the logic database manager 415 including monitoring a normalization index established for tracking stochastic functions. The normalization is a tracking of the activity to a state of normality or when there is a motivation to act.

The data flow is pulled from the Node, Edges and Graph Data 445 and the analysis is passed back to the core logic engine 415. After processing the sub-properties data is sent to the clearinghouse database through the database mapping and update system 435. This is an example process of the valuation of a decision process identified for graph nodes and holders.

The Valuation and Revenue System is defined by the integration of the valuation model, revenue models in the core logic system 410, and classification system and properties comparables calculated a valuation & revenue monitoring and indexing system 460. The valuation revenue modeler 420 uses core valuation techniques including graph assets equity (GAV), graph equity (GE), graph assets lifetime value (GALV), graph lifetime value (GLV) and customer retention probability (CRB) formulas to derive and deliver a real time valuation. The real time formulas include integration into the information extraction and retrieval and exchange platform with MAP or Mean Average Precision tracking and database 465.

The MAP tracking and database system 465 measures the results from extraction and retrieval of information to the core logic engine and system operations. These metrics are utilizes by the core logic engine to refine and optimize processes, routing, stored procedures, formulas and algorithms.

Cash flow data is derived from the social e-commerce & revenue classification index 485 system. This system tracks and records within the classification database all forms of commerce related to social and e-commerce revenue including advertising. This data is compared and linked to the graph assets properties of the customer.

The core logic engine platform 405 valuation & revenue modeler 420 utilizes formulas to assess the graph and graph asset values. Examples as follows:

In order to determine the GLV of customer i of group c (GLV_{c,i}), we obtain the present value at the beginning of period c of all cash flows CF_{c.i.t}εIR that the social graph expects to receive from the customer over the entire relationship. Assuming T_{c,i}ε IN as the duration of the customer's relationship (for existing customers: remaining duration) and index t as the period of the customer relationship (for existing customers: period since the instant of valuation), GLV_{c,i} can be expressed as follows:

$$GLV c , i = {\sum }_{i = 0}^{Tc , i} \frac{CFc , i , t}{{( 1 + d )}^{t}}$$

where CF_{c,i,t} denotes the cash flow in period t of the customer relationship for customer i of group c and
T_{c,i} the duration of the customer relationship for customer i of group c.

Incorporating the GLV approach for determining the value of the social graph, we first partition all existing and future customers into different groups c (with c=0, 1, . . . ), where c denotes the period in which the customer joined or will join the social graph. Then customers are referred to as i=1, . . . , Nc for each group c, whereas all existing customers at the instant of valuation are assigned to group c=0. With this notation, an social graph's GE can be expressed as the sum of discounted GLVs of all existing (group 0) and future (groups 1, 2, . . . ) customers2:

$$GE = {\sum }_{c = 0}^{∞} \frac{{\sum }_{i = 1}^{Nc} GLV c , i}{{( 1 + d )}^{c}}$$

where GE denotes the total value of all existing and future customer relationships,
GLV_{c,i} the GLV of customer i of group c,
N_{c} the number of customers in group c (with N_{c}εIN) and
d the periodical discount rate (with dεIR⁺).
where r_{c.i.t} denotes the retention rate for customer i of group c in period t,
e_{c,i,t-1} the number of contacts of Node i of group c in period t−1 and

These formulas combine with a retention rate to establish the value of graph assets. Graph assets properties and Sybil tracking 450 are utilized to test the integrity of the graph network. The system incorporates a notification system to alert LDAP and suspend accounts and access in the event malicious activity or attack edges are discovered and request enhanced authentication such as mobile numbers for sms codes for authentication.

Hub and Authority classifications can be formatted for graphs provides similarity to the internet network but for graph networks. Nodes act similarly to Authority and Edges to Nodes. So the number of active connections to a Node is in effect the measurement of Edges and the number of links to a Node is the measurement of Authority.

The Graph Assets Equity (GACE) and Graph Assets Lifetime Value (GALV) are based on and formulas in this embodiment similar to GE and GLV. Combined the result is a utilization of the Core Logic Engine Platform 405 and valuation and revenue modeler 420 to determine valuation and graph information from the information extraction and retrieval system 465 and revenue determination using Social and E-Commerce Revenue Classification 485 real time for the SGEC Classification Database and numbers to complete the GLV or GALV. This provides the central point for GE or GAE based on the number of customers or individuals within the graph which is utilized to establish GE or GAE by multiplying the GLV and GALV.

The number of solutions and formulas is only limited to the number of opportunities for valuation and can be adjusted based on vendor or monetization protocol requirements.

The social credit rating score is a combination of history and factors such as influence and community. This invention provides a platform for many different scoring services. Social credit rating can affect and some say replace the credit rating agencies in the future. The invention starts with the creation of a graph file, a graph file from a specific node and the nodes and edges that are within that graph. This process starts with data from the graph IERE 465 and graph data 445 populated to the core logic engine platform schema 405. The process starts with an inquiry and ends with a rating. The system assess what value and influence is in the graph utilizing the hub, authority or edges and nodes data as well as clustering coefficient 455 to determine the intensity of the graph holders network and the authority and influence within their community. This combined with the number of nodes within the graph are factors that are known in the data normalization data versus unknown. Utilizing the sub-properties and RBF logic engine for additional scoring the system can provide information to increase the social credit rating by watching service provider request trending 465 including through the API layer 470. The invention is designed to track information without this API but the API also provides the graph holder with the option to allow or disallow anonymous connection data to be communicated to the social credit rating user.

The system then reviews the links within the classification database 435 to the graph and creates an assessment of the degree of social activity and the degree of commerce related activity as determined by the logic engine 410 and manager 415. This data along with the clearinghouse graph assets held by the graph holder allow the system to establish a rating. The threshold of what that rating would be, how it would be displayed against other ratings, is determine by the service provider. The basic mapping and scoring 475 is also available through the graph logic search engine 490.

The custom & programmable algorithm database 430 is integral in the operation of the invention. It provides algorithms and scheduling requests through a priority rating system. This system allows the core logic engine platform 405 to assess and determine the variables to address in the IERE algorithm settings sent to the information extraction and retrieval system FIG. 3. Algorithms used for node and edges include: topological sort, finding shortest path, minimum spanning tree or weight reduce, and breadth first or FIFO as below are adjusted by the core logic engine for maximization based on the system need 410:

There are many variables and threshold that can be set and explored using this system and method. The plurality of data structures and additional calculations and formulas for determining valuation and monetization for graphs and graph assets is almost unlimited with this invention core.

A topological sort or ordering of a directed graph is a linear ordering of its edges such that, for every edge ab, a comes before b in the ordering. The edges of the graph may represent tasks to be performed, and the edges may represent constraints that one task must be performed before another. A topological ordering is just a valid sequence for the tasks and used to sort out a work schedule based on the dependency tree. The algorithm is as follows:

```
# Topological Sort
# Input records
[node_id, prerequisite_ids]
# Output records
[node_id, prerequisite_ids, dependent_ids]
class BuildDependentsJob {
  map(node, prerequisite_ids) {
    for each prerequisite_id in prerequisite_ids {
      emit(prerequisite_id, node)
    }
  }
  reduce(node, dependent_ids) {
    emit(node, [node, prerequisite_ids, dependent_ids])
  }
}
class BuildReadyToRunJob {
  map(node, node) {
    if ! done?(node) and node.prerequisite_ids.empty? {
      result_set.append(node)
      done(node)
      for each dependent_id in dependent_ids {
        emit(dependent_id, node)
      }
    }
  }
  reduce(node, done_prerequsite_ids) {
    remove_prerequisites(node, done_prerequsite_ids)
  }
}
# Topological Sort main program
main( ) {
  JobClient.submit(BuildDependentsJob.new)
  Result result = [ ]
  result_size_before_job = 0
  result_size_after_job = 1
  while (result_size_before_job < result_size_after_job) {
    result_size_before_job = result.size
    JobClient.submit(BuildReadyToRunJob.new)
    result_size_after_job = result.size
  }
  return result
}
```

A spanning tree is a graph and sub graph that connects all the edges and nodes together. It can assess weight of each edge and assign a weight to a graph (spanning tree) by computing the sum of the weights of the edges in that graph. A minimum graph or minimum weight of the graph is then a graph tree with weight less than or equal to the weight of every other graph in the vertex. The algorithm is as follows:

```
# Minimum Spanning Tree (MST)
Adjacency Matrix, W[i] [j] represents weights
W[i] [j] = infinity if node i, j is disconnected
MST has nodes in array N = [ ] and arcs A = [ ]
E[i] = minimum weighted edge connecting to the skeleton
D[i] = weight of E[i]
Initially, pick a random node r into N[ ]
N = [r] and A = [ ]
D[r] = 0; D[i] = W[i] [r];
Repeat until N[ ] contains all nodes
  Pick node k outside N[ ] where D[k] is minimum
  Add node k to N; Add E[k] to A
  for all node p connected to node k
    if W[p] [k] < D[p]
      D[p] = W[p] [k]
      E[p] = k
    end
  end
end
```

The invention is designed with MapReduce and the following Single Shortest Path Algorithm. The shortest single path is finding a path between two vertices (or nodes) in a graph such that the sum of the weights of its edges is minimized.

```
# Single Source Shortest Path (SSSP)
Adjacency Matrix, W[i] [j] represents weights of arc
    connecting node i to node j
W[i] [j] = infinity if node i, j is disconnected
SSSP has nodes in array N = [ ]
L[i] = Length of minimum path so far from the source node
Path[i] = Identified shortest path from source to i
Initially, put the source node s into N[ ]
N = [s]
L[s] = 0; L[i] = W[s] [i];
Path[i] = arc[s] [i] for all nodes directly connected
from source.
Repeat until N[ ] contains all nodes
  Pick node k outside N[ ] where L[k] is minimum
  Add node k to N;
  for all node p connected from node k {
    if L[k] + W[k] [p] < L[p] {
      L[p] = L[k] + W[k] [p]
      Path[p] = Path[k].append(Arc[k] [p])
    }
  }
end repeat
```

# Here is the map/reduce pseudo code would look like

```
class FindMinimumJob
  map(node_id, path_length) {
    if not N.contains(node_id) {
      emit(1, [path_length, node_id])
    }
  }
  reduce(k, v) {
    min_node, min_length = minimum(v)
    for each node in min_node.connected_nodes {
      emit(node, min_node)
    }
  }
}
class UpdateMinPathJob {
  map(node, min_node) {
    if L[min_node] + W[min_node] [node] < L[node] {
      update L[node] = L[min_node] + W[min_node] [node]
      Path[node] =
        Path[min_node].append(arc(min_node, node))
    }
  }
}
# Single Source Shortest Path main program
main( ) {
  init( )
  while (not N.contains(V)) {
    JobClient.submit(FindMinimumJob.new)
    JobClient.submit(UpdateMinPathJob.new)
  }
  return Path
}
```

The single shortest path and also be addressed using breath-first search of first-in first-out (FIFO).

```
# Breadth-first search (BFS)
Adjacency Matrix, W[i] [j] represents weights of arc
  connecting node i to node j
W[i] [j] = infinity if node i, j is disconnected
Frontier nodes in array F
L[i] = Length of minimum path so far from the source node
Path[i] = Identified shortest path from source to i
Initially,
F = [s]
L[s] = 0; L[i] = W[s] [i];
Path[i] = arc[s] [i] for all nodes directly connected
from source.
# input is all nodes in the frontier F
# output is frontier of next round FF
class GrowFrontierJob {
  map(node) {
    for each to_node in node.connected_nodes {
      emit(to_node, [node, L[node] + W[node] [to_node]])
    }
  }
  reduce(node, from_list) {
    for each from in from_list {
      from_node = from[0]
      length_via_from_node = from[1]
      if (length_via_from_node < L[node] {
        L[node] = length_via_from_node
        Path[node] =
          Path[from_node].append(arc(from_node, node))
        FF.add(node)
      }
    }
  }
}
# Single Source Shortest Path BFS main program
main( ) {
  init( )
  while (F is non-empty) {
    JobClient.set_input(F)
    JobClient.submit(FindMinimumJob.new)
    copy FF to F
    clear FF
  }
  return Path
}
```

There are many variables and threshold that can be set and explored using this system and method. The plurality of data structures and additional calculations and formulas for determining valuation and monetization for graphs and graph assets is almost unlimited with this invention core.

The management process for a programmed and scheduled algorithm is to generate a variable populated instruction set from these generic algorithms along with the priority rating. These are examples of the node and edge algorithms but many others can apply including retrieval algorithms for example for streaming media. There are many structures and combinations and Node or variables required for the core logic engine platform 405 were used as an example only.

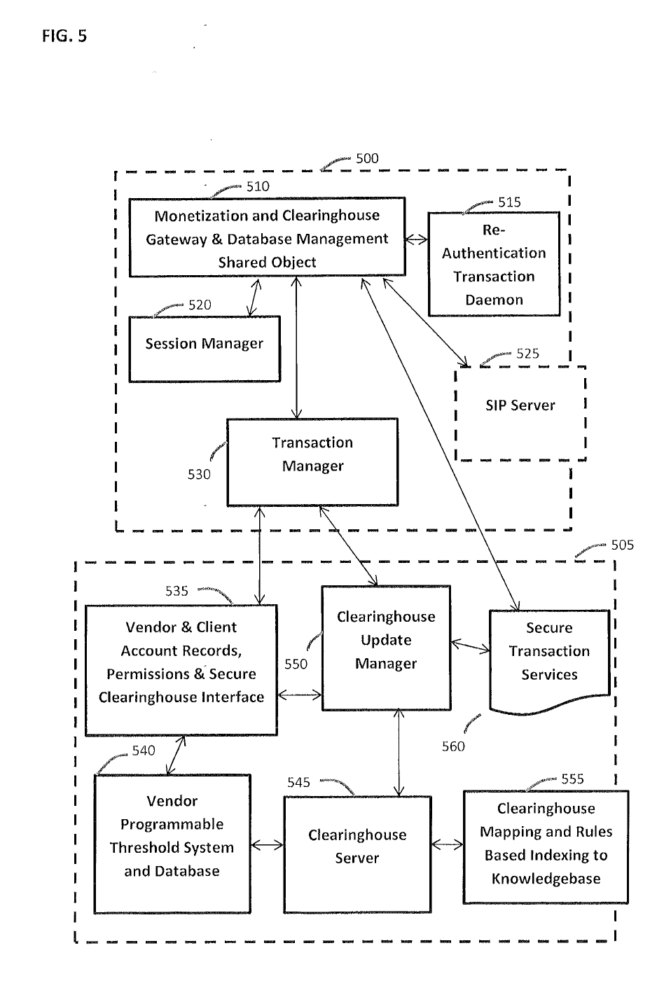

Referring to FIG. 5, the monetization and classification system of an embodiment of the present invention is shown. The system uses SOAP (Simple Object Access Protocol) for transferring messages between applications, SIP (session initiation protocol) for session management with SDP (session description protocol), and WSDL (Web Services Description Language) for defining web services and interfaces, and secure SOAP or XML or XML with SSL for protecting the communication in the transactional components of the invention.

This protected environment of the clearinghouse is important as it is used by the Vendors of the invention to secure and collateralize financial or interchange services 535. Until now there were no tools to exploit the opportunity to monetize graph and graph assets and the monetization process needs to be as secure as financial transactions. A Monetization and Clearinghouse Gateway and Database Management Shared Object with stored procedures and operating functions 510 is an inter-site gateway and monitors states, authentication, authorization and processes.

The following is a generalized example of the transaction manager and how it coordinates all the processes to satisfy an approval process or collateralization of a financial or interchange process. Prior to this process the Vendor has set collateral or asset thresholds and placed into the Vendor Profile 535.

In the following embodiment, the client, CuiInitial, has set up a session with the SIP server, has been transferred utilizing the inter-site transfer service to the Monetization and Clearinghouse Gateway and Database Management Shared Object 510, and the Monetization and Clearinghouse System Transaction Manager has assigned a Session ID 520.

CuiInitial gets the session ID from the SIP server 525, it invokes the createTX( )method in TXManager (Transaction Manager 530) to create a new transaction; CuiInitial gets a unique transaction ID from TXManager 530; CuiInitial can now invite transaction participants and it send a message to the Clearinghouse 545 to join the transaction; Clearinghouse 545 then joins in the transaction by invoking TXManager joinTX( )method; TXManager 530 returns the joining result to Clearinghouse with confirming information; the Clearinghouse service gets the confirmation result from TXManager 530 and gives CuiInitial an invitation response to indicate that it has joined in the transaction; CuiInitial invites the Service Provider (financial service or interchange provider) 535 to join in the transaction; CuiInitial gets all the invitation responses from the Clearinghouse 545 and Service Providers 535, it tells TXManager 530 to hold the required graph assets or collateral 540 subject to notification to the Clearinghouse 545 record and that the Vendor 535 has accepted the transaction or approved the credit facility by invoking the commit( )method in TXManager 530; TXManager 530 then gives the graph asset(s) information to Clearinghouse 545 and Vendor Collateralization System 540 and asks them to prepare for approval or collateralization of the required graph asset(s); the Clearinghouse Update Manager 550 checks the graph assets classification and state information, they each give a prepared response to TXManager 530 which declares that they have prepared for the approval or collateralization 540; once the TXManager 530 receives the prepared responses from both the Clearinghouse Update Manager 550 and Vendor Collateralization System 540, it commits the collateral state and then gets the transaction states from SOAP; finally, TXManager 530 sends the approval or collateralization result to CuiInitial; WebMsgClient returns the checking session result to Session Manager 520 TXManager 530 with a boolean value; the boolean value will be sent from TXManager 530 to SOAPRequestHandler; after receiving a positive result, the listcategory( )method call will be delivered to TXManager 530; TXManager 530 makes use of TXDBHandler to query the database of the service provider and returns the result; during the procedure of generating a SOAP response to the client, a SOAPResponseHandler is used to get the Session ID 520 from the TXManager 530 through invoking the setSOAPHeader method of TXManager 530; then the SOAPResponseHandler will add the Session ID 520 into the SOAP header element of the SOAP response message; the SOAP response message is received by TXManager 530; TXManager 530 informs the Clearinghouse 545, Vendor Collateralization System 540 and Vendor 535 the transaction has been successfully completed.

In this embodiment the clearinghouse uses directory structure within the URI protocol used for the graph logic search engine and inverted index referencing is Node: [ID]/graph/asset/properties/ or Nodes: [ID]/graphs/assets/properties/. The monetization threshold is appended to the Client Account record 540 which is related with the [ID] to the Clearinghouse 545. Clearinghouse Mapping and Rules Based Indexing is managed by the Knowledgebase or Core Logic Engine Platform FIG. 4.

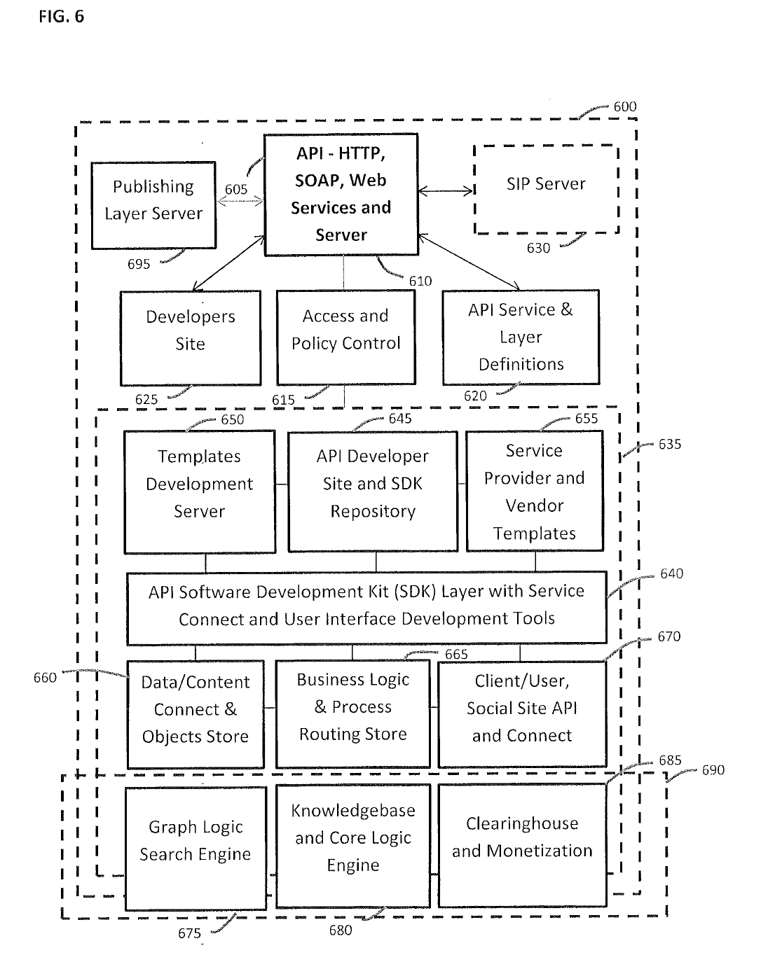

Referring to FIG. 6, a generalized diagram of the API and Layer servers, services, definitions, provisioning, and control policy systems of the invention is shown. The API and Layers system is envisioned to provide the most flexible platform for delivering options to vendors, service providers, customers, all users of the graph logic engine and classification system. The API or application programming interface provides the back-end for developers to create new services, applications and markets using the plurality of services that can be envisioned by business and entrepreneurs.

The API platform can be viewed as an extension of the social Internet with the network the community you build, not the systems you use. The invention is built with a model that can work within any environment and protocol. Utilize the reach of the internet and maximize future services of graph and graph assets holders. The example embodiment below is built on the SOAP (Simple Object Access Protocol), SIP (session initiation protocol), SDP (session description protocol), and WSDL (Web Services Description Language) platform as in FIG. 5 with Java enabled Client.

The API Layers have core components such as: API Layer Server 605; Developers Site 625; Publishing or Application Site and Server 695; Data Connect and Content Object Stores 660; Business Process and Routing Store 665; Client/User, Social Site API and Connect 670; Authentication Gateway 630; Access and Policy Control 615; and Database connect stores such as Graph Logic 675; Knowledgebase and Core Logic Engine 680; and Clearinghouse and Monetization 685.

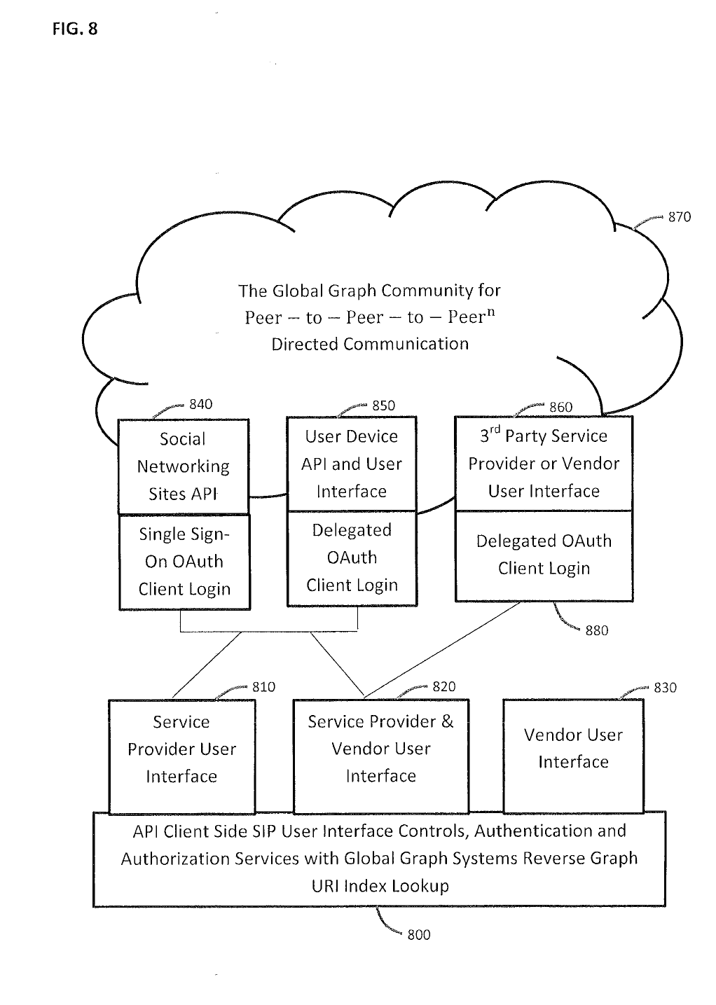

The SOAP or API Client sends SOAP requests and receives SOAP responses over HTTP; the SOAP API Client is developed for and by Service Providers (in Java, Visual Basic or C++); a Web Server 605 receives SOAP requests and gives responses to the SOAP client FIG. 8; in order to parse both the HTTP header and SOAP messages sent from the Web server contain a SOAP Server 605; a SOAP Server 605 (or a SOAP Engine) parses SOAP request messages and invokes the appropriate Web Service then generates a SOAP response messages to SOAP clients FIG. 8; AXIS version 3 of Apache SOAP in which Java is used to implement standard SOAP is implemented; Axis is the SOAP server to be used in the system; Web Services provide services for the Service Providers clients to use and the functions of the services are based on the business requirements; services have back end database connectivity and development support. Web service programs can be developed in Java, C++, and Visual Basic as well as other languages. The embodiment envisioned here uses Java.

When a Client, Service Provider of Vendor contact the API Server and systems the platform provides a series of tools and services for any social application in the graph assets, valuation, scoring or monetization business. When the user has registered and activated services the system provides many useful processes and tools are available including Data Connect Objects for API Layers with: layer creation; layer editing; layer testing; layer ownership transfer; layer publication; and layer services design and connect. The system provides a: API Layer Definitions 620 and Service Definitions 620 Server for accurate development and provisioning of services. An Access and Control Policy Server tracks the permissions and authorization through OAuth and SIP Session ID 630. The system provides modules and tools such as a Template Development Server 650; API Development Site and Software Development Kit (SDK) Repository 645 as well Service Provider and Vendor Templates 655 for ease of registration and provisioning. The API Software Development Kit (SDK) with Service Connect and User Interface Development Tools 640 provides the User with object templates for quick access to the core databases within the invention. The developer registers and requests the API Key for each project to link the API Database Connect into the developed layers. These database sources include the Graph Logic Search Engine 675; the Knowledgebase and Core Logic Engine 680 and the Clearinghouse and Monetization system 685. These three data sources are the access points to the complete back-end core and data 690.

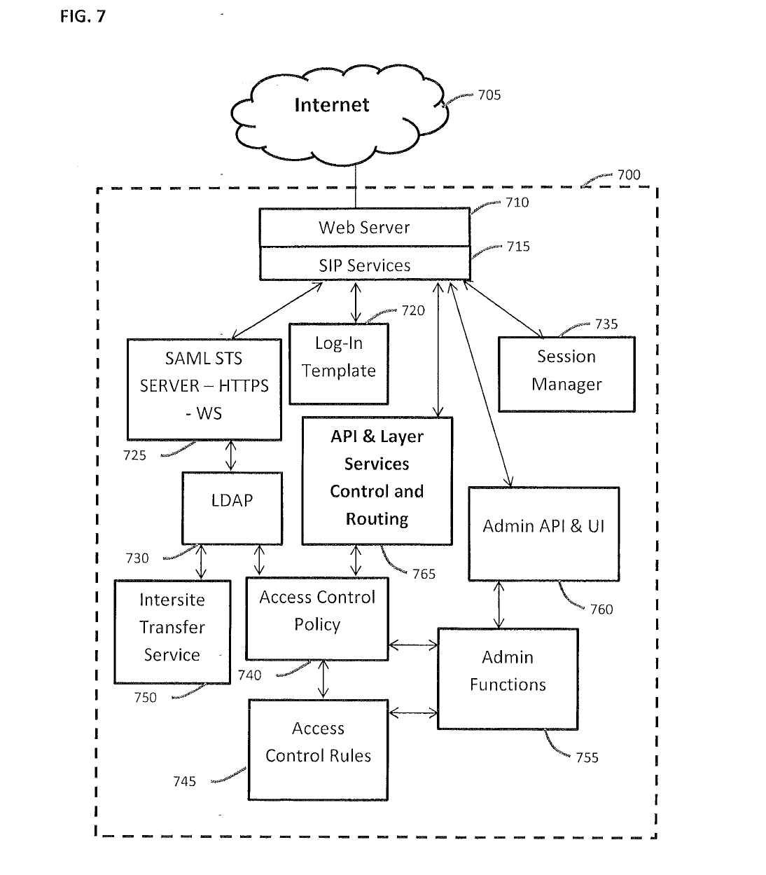

Referring to FIG. 7, a generalized description of the authentication and authorization process envisioned within the invention is shown.

We provided SAML for this embodiment as it supports secure interchange of authentication and authorization information by leveraging the core Web services standards of XML, Simple Object Access Protocol (SOAP), and Transport Layer Security (TLS) as well as Single Sign-On technology.

Using Single Sign-On authorization, a request is made to or from the external service specified. Using an embedded browser the client asks for authorization from the user to a managed URL; the authorization server detects the user request to authenticate and redirects to SAML LDAP; the URL for authorization is passed via a RelayState parameter; user accesses their IDP and authenticates; authentication is performed by the IDP; when authenticated the IDP sends a SAML Response though the Client browser with RelayState to the OAuth authorization or STS server; the SAML assertion is accepted and logs the user in; the digital signature applied to the SAML Response allows verification that the message is from a Client system at which points the user is authenticated and redirected to the STS server; the user authorizes the application; once authenticated the user is prompted to approve the application connecting; the application is issued an OAuth token; the application is issued a high-entropy token that can be used to establish a session for the user by the application; subsequent usage of the application does not require the user re-enter their credentials.

A simple outlined of the Embodiments SAML system is as follows: a user can login at one site; a SAML assertion transfers the user authentication token; and the transferred token provides authentication to a remote site. A SAML package can include the authentication token as well as user attributes that can be tested against the rules engine for authorization and access control. This provides the backbone for the Social Site API connectivity as well as the services developed by the API Developers and Service Providers. It also provides the ability for Single Sign-On integration for service provider customers and applications.

SOAP over HTTPS offers secure authentication, including for the Clearinghouse and Monetization platform. The embodiment uses an LDAP 730 server for identity and subsequent a STS SAML-based server 725 for sending security assertions. The SAML token is used to pass assertions to trusted resources, which then approve or deny access to data resources. The service uses a rules engine to evaluate authorization rules based on security policies that specify conditions for approval or denial of access to data resources through Access Control Policy 740 and Access Control Rules 745. The rules engine is central to reinforcing policy management.

Using LDAP as the authoritative source also supports a centralized source for identity management. Rather than managing resource access at the individual resources, user access lists can be managed by using the LDAP and the appropriate policies that define user roles and corresponding data parameters, such as department and management level.

The user wishes to access services or the API Development of Publishing Environment. They use a SOAP Services 715 to login with a username and password pair. The client passes the pair to LDAP 730 for authentication. LDAP 730 validates the user and returns the information to the client 715; SOAP Services 715 passes the returned LDAP 730 information and other user information to the SAML client 725, which is a service that packages the information in the correct format as a SAML token; SAML client returns the token to the SOAP Services 715. The SOAP Services 715 wraps the SAML token (STS Server) 725 and the user request into a SOAP request; SOAP Services 715 starts a timed SAML session 735 and sends the SOAP request to the appropriate Web service 765 to fulfill the user requirement. The Web service 715 parses the SAML token and verifies the authentication information via LDAP 730 (the user only logs in once as each Web service can serve as a user surrogate and is trusted by the data resource because the Web service verifies request information); after authentication the Web service 715 sends a request to the SAML server that's running the rules engine 740. The rules engine 740 evaluates user parameters and determines the level of access that the user is authorized. The evaluation is based on a set of rules that reflect predefined access policies. Verification of access level is returned to the Web service 715; Web service requests data from the data resource packages of the API & Layer Services Control and Routing Server 765.

A SAML-based service that uses LDAP 740 as a centralized authority can enforce security policies and achieve centralized identity management. Group or Delegated Authentication can be created with LDAP 730 and SAML 725 instruction sets. The group structure provides the customer or new API Layer the ability to set approval setting for customers and users including Single Sign-On authority.

This Web service 715 provides a generalized service for assertions, certification, and access. API Developers can call this Web service to allow their Web services to gain access to targeted applications and data resources including Peer-to-Peer-to-Peerⁿ marketing through the core logic engine and classification platform utilizing sub-properties profiles of nodes and graph assets outside the user account existing graph.

Referring to FIG. 8, a simplified diagram of the API Client Layer for the Service provider and Vendor is shown.

The business and customer dynamics of the current e-commerce models do not provide opportunities for social e-commerce or monetization. The platforms are designed to pull from the old contextual and semantic model which undermines and misses a plurality of opportunities including managed viral marketing with tracking. The service providers 810, 820 and vendors 830 are enabled with access to sub-properties tracking through the core logic engine and clearinghouse system.

The API user interface 800 is designed for true social e-commerce without limits to enable users and customers to also access the Peer-to-Peer-to-Peerⁿ 870 marketing tools and opportunities.

The API Client 840, 850, 860 of this embodiment is focused on fulfilling this through an integrated single sign on system with mobile worldwide access to trends, paths, and shared graph assets properties and sub-properties providing a true viral marketing campaign system with intelligent campaign development and tracking. Combined with the other features of this invention this open platform will enable opportunities for existing platforms was unavailable.

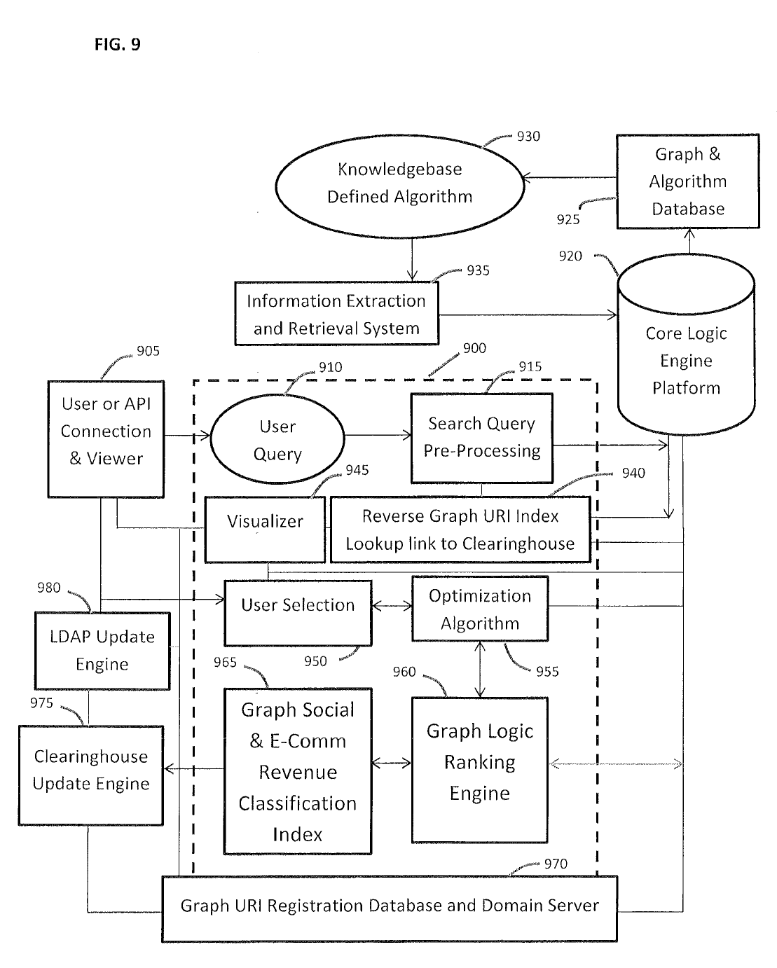

Referring to FIG. 9, a simplified diagram of the graph logic search engine is shown. This design utilizes known models for operations without the limitations associated with current search engines. The graph logic system utilizes a graph based ranking utilizing a graph classification system and core logic engine. It provides a Reverse URI Index Lookup for Graph Registration and access exchange and a Graph Domain Registration and Server.

It works with the knowledgebase and core logic engine to deliver information and visualization models that are currently unattainable. The graph logic search engine provides visualization of graph usage, best practice routing based on graph assets properties and sub-properties.

The graph logic model delivers true graph logic without re-ranking as in existing inventions for existing models. The visualization system provides a unique floating search and graph domain bar with drop down data 1120 for queries about specific nodes, edges or other components of the graph or graph assets. This visualization includes factors such as location, source, top node or authority, specific topic, and new paths for expanding networks.

The graph logic search engine looks for routing of answers through nodes or authorities. The floating search and graph domain bar with drop down data 1120 allows the viewer to click on any node or graph holder and enter a query to find the known source or graph path.

The graph logic search engine uses integration into the core logic engine platform 920 and the social and e-commerce revenue index 965 to populate the visualization system. The search query system 910 uses query pre-processing 915 to integrate into the graph system and core logic engine 920. The core logic engine graph 925 defined algorithm 930 creates unique advantages for users. The graph search algorithms are updated real time based on the information from the extraction and retrieval system 935 and core logic engine. This delivers unique opportunities for every search request for every time it is used it has current graph information including real time viewing. This dynamic system provides real time business opportunity and knowledge tracking for a next generation graph engine. Real sourcing and trending results by pathing or tracing to the source and reverse indexing requests based on real time graph properties and sub properties available only utilizing the core logic engine of this invention.

### Description of Specific Embodiments

### Graph Search and URI Registry Request Interface

The user is directed to the search site or home page 1000 in a variety of ways for a variety of reasons. For example, the user may be following a bookmark, clicking on a link from an email, or allowing their browser to auto-complete or re-direct.

The user 905 enters a social networking site name “social networking site” and their “ID or email address” 1010 to view their graph. The system sends the query 910 to the pre-processing 915 service to format for LDAP and Clearinghouse lookup. This query forwards through the reverse graph URI index lookup link to the clearinghouse 940 to check for records. If the records are found they are forwarded to the visualizer 945 for viewing by the user 905. If the records are not found they are forwarded to the graph URI registration database and domain server 970 to register the graph and this updates the clearinghouse through the clearinghouse update engine 975 and the LDAP records through the LDAP updated engine 980. The request is then sent to the information extraction and retrieval system 300 through the core logic engine 905 for priority updating of graph and graph assets information. The results page and link 1100 are delivered through the visualization platform to the viewer 945 through the URI Index Lookup 940 for confirmation of updated data.

### API Developer Creates Templates for Graph Valuation Companies, Social Credit Scoring Companies, and Monetization Companies

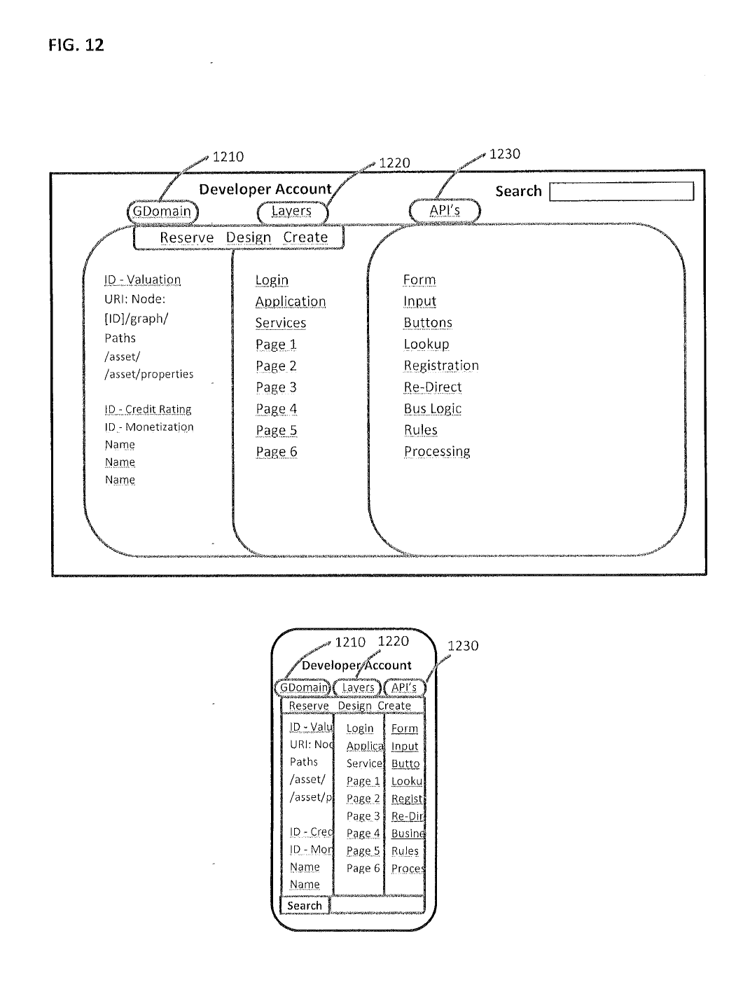

To create Layers and connecting API's the developer need to create a Development Account or Login; if they have not been approved they need to fill in the developer signup form and accept the terms & conditions; they will then be directed to the Layer and API Developer Site FIG. 12; the GDomain 1210, Layer 1220 and API 1230 tabs are shown and they can start work for customers.

When the Developer accepts a job and registers as a developer for their GDomain or creates a GDomain account for the customer to place the GDomain it into the Developer Site.

To assure they can connect the database API's the developer needs to request an API Key. Once they have received this Key they can now connect to the necessary databases and functions to the customers site.

The Developer has the tools to necessary create, publish and sell custom applications; the first template project in the API Layer development environment is a Valuation service 1210 for [ID]. The project utilizes the database & content connect 660 feature; the pages are designed so the customer can set custom thresholds and incorporate business rules & processing logic 665 into the database connect objects; database connect objects contain the functions and stored logic for access to the clearinghouse and monetization 685 system; these template objects are available in the data/content connect and objects store 660; the project is completed and placed on the Layer and API publishing site for testing and approved release; the testing includes API database connectivity, security audit and authentication services settings 700; once the service is tested and running the developer releases the ID-Valuation GDomain to the customer.

The Developer has taken on a second project. This project involves the Social based Credit Scoring; the developer realizes database connectivity and customized thresholds therefore once more requests a new API Key; the Social Credit Rating application will require indirect connectivity into the Logic Database 410 as well the Logic Database Manager 415; a scoring Object is selected from the business logic & process routing store 665 and linked to the Clearinghouse; the Clearinghouse provides the sub properties data from the Classifications associated with an individual customer; the Logic Engine 410 and Logic Database Manager 415 can use stochastic processes to populate the sub properties records and based on a probability and comparison table utilizing the E-Commerce Revenue System data provided by the Information Extraction and Retrieval System Exchange Platform 465 the customer receives a real time social scoring solution.

The next project is a Financial Services Company that is looking for a platform for identifying new customers with real time credit monitoring. The developer takes on the project and starts by receiving a new API Key.

The developer creates or develops on the customers GDomain; the developer creates new Layers for the customer and connects the Layers into the Clearinghouse and Monetization System; this system requires either Transport Layer Security or SSL to work with these systems; the developer sets up a test account to assure the authentication and secure communication process is operating properly through the monetization and clearinghouse gateway and shared object 510; once this is assured the developer tests connectivity to the clearinghouse service to assure that the customer can request changes in the state of customers or graph holders assets; this account 535 requires a secret transaction key which is requested by the customer and interface provided to the customer to assure they can view the monetization and clearinghouse account interface; the developer places the monetization and clearinghouse objects into the Layer and send to the publishing server 695 for testing; the project includes custom settings for asset thresholds and other factors such as social credit scoring and valuation services; once this has passed the GDomain is released the financial service provider Vendor integrates the application into their customer acquisition platform.

### Peer-to-Peer-to-Peer Marketing & Advertising Company

The Peer-to-Peer-to-Peer, etc., solution is a natural application for this invention. With the sub-properties available to the logic and knowledgebase engine 405 the system can trace a path for almost any commerce need in a viral manner with viewable tracking. This can be incorporated into the authentication and authorization 700 system to provide a one stop solution for logins and signups. The invention possibilities are limited only by the service provider creativity.

### Graph Access Brokering Service Company

The graph access brokering service company can be established simply by incorporating the Vendor platform into a Buy-Sell-Auction platform such as eBay. Holders of social graphs have unlimited potential and with a graph access brokering company they can buy, sell and auction their graph “pathway” as can others and create a strong and fruitful business and marketing system which again is only limited in its structure by the creativity of the service providers. Access to the Logic Engine and Sub-Properties creates a knowledge source for the best practices and business processes, the next generation of market intelligence.

### Social Networking Site

A developer receives a project where the customer wants to deliver an integrated solution for its customers. The customer wants a platform that delivers real marketing solutions, real and integrated valuation services including real time, social credit scoring pop ups and advice in real time, monetization services and offers, a graph brokering exchange and all the traditional features of other social sites. The developer proposes to build the site on a traditional FOAF (Friend of a Friend) model which the some of the largest sites are functioning with OAuth single sign-on authentication.

The developer requests an API Key and starts the project; the developer reserves a new GDomain for the customer and updates the URL record to the domain the customer wishes to sync the project; the shell of the FOAF system is loaded on the URL and the API's are developed as plug-ins for the social networking site; these API's include connectivity to real time valuations service providers 460 as well the data connect object 660 connecting the classification and monetization system is included; and a social credit scoring platform or service provider API plug in provided; the social networking site is now enabled with all the tools to manage the users social connections from purpose specific sites such as LinkedIn and foursquare and Broad-based networks such as Facebook, Twitter and Google+ and many others; a true centrality with Asymmetric and Symmetric properties and access to sub properties of other users within their graph for easy knowledge and commerce solutions which are yet to be realized or built.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art. The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network. Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as a combination of both software (e.g., a computer program product) and hardware. Still other embodiments of the invention may be implemented as entirely hardware, or entirely software e.g., a computer program product).

A person understanding this invention may now conceive of alternative structures and embodiments or variations of the above all of which are intended to fall within the scope of the invention as defined in the claims that follow.

What is claimed is:

1. A system for a graph logic and classification engine comprising:
a core logic engine;
a graph classification system;
a scoring platform;
a valuation and monetization system;
an information retrieval and extraction system; and
a graph logic classification engine with graph domain registration and server,
wherein,
the graph logic and classification system defines data service needs and customizable algorithms and scheduling for infrastructure operation;
an information logic technique track and analyze properties associated with at least one graph asset;
an auto-learning toolset provides core learning and discovery protocols and architecture to search external information centers and internal data using probability analytics;
graph logic information extraction and retrieval services optimizes data modeling;
a graph and graph asset record is populated that relates to a profile ID for real time search classification and indexing creates a uniform resource identity (URI) infrastructure;
an intelligent system identifies data for populating an e-commerce and revenue indexing system;
a secure vendor interface that provides access to the |graph classification system|[S2]; and
a fraud detection system for tracking a malicious user account and suspending the malicious user account or requiring a next level authentication.

2. The system recited in claim 1, wherein the graph logic and classification engine uses a programmable logic engine.

3. The system recited in claim 1, wherein the graph logic and classification engine populates a programmable algorithm with a plurality of business, database logic and stored functions.

4. The system recited in claim 1, wherein the graph logic and classification engine manages a graph URI classifications system.

5. The system recited in claim 1, wherein the graph logic and classification engine provides aggregated graph classification.

6. The system recited in claim 1, wherein the graph logic and classification engine uses an automated schema evolution system.

7. The system recited in claim 1, wherein the graph logic and classification engine uses a subtype polymorphism or inclusion polymorphism system.

8. The system recited in claim 1, wherein the graph logic and classification engine provides graph and graph assets valuation systems.

9. The system recited in claim 1, wherein the graph logic and classification engine uses graph based customer equity and customer lifetime value logic and formulas.

10. The system recited in claim 1, wherein the graph logic and classification engine uses customer retention logic and formulas for valuation models.

11. The system recited in claim 1, wherein the graph logic and classification engine uses a normalization index established by the radial basic function engine for tracking stochastic functions.

12. The system recited in claim 1, wherein the graph logic and classification engine uses a social e-commerce & revenue classification system and database for cash flow and market data.

13. The system recited in claim 1, wherein the graph logic and classification engine uses monetization models and systems for graphs and graph assets.

14. The system recited in claim 1, wherein the graph logic and classification engine provides a graph assets collateralization system and controls.

15. The system recited in claim 1, wherein the graph logic and classification engine uses an API and Layer Platform and Architecture to deliver infrastructure services.

16. The system recited in claim 1, wherein the graph logic and classification engine uses a peer-to-peer-to-peer marketing system.

17. The system recited in claim 1, wherein the graph logic and classification engine enables a graph domain registration system and server.

18. The system recited in claim 1, wherein the graph logic and classification engine enables a graph logic search engine floating search and graph domain lookup bar with drop down data.

19. The system recited in claim 1, wherein the graph logic and classification engine enables a best practice routing for marketing based on graph assets properties and sub-properties.

20. The system recited in claim 1, wherein the graph logic and classification engine enables real time tracking of graph status through a real time update and visualization system.

21. The system recited in claim 1, wherein the graph logic and classification engine uses a plurality of database models and designs.

22. The system recited in claim 1, wherein the graph logic and classification engine uses a plurality of operating systems and network protocols.

23. The system recited in claim 1, wherein the graph logic and classification engine uses a plurality of data structures, calculations and formulas for determining a valuation and monetization for the graph and graph asset record.

24. The system recited in claim 1, wherein the auto learning toolset includes protocols and algorithms.

25. The system recited in claim 1, wherein the auto learning toolset searches information centers and internal data for opportunities, trends, graph assets, markets, and user profiles.

26. The system recited in claim 1, wherein the intelligent system identifies data, wherein the data includes graph and graph asset classifications, e-commerce and traditional markets data.

27. The system recited in claim 1, wherein the profile ID is a URI.
